(19) United States
(12) Patent Application Publication
(10) Pub. No.: US 2016/0358623 A1
(43) Pub. Date: Dec. 8, 2016

(54) OPTICAL INFORMATION RECORDING/REPRODUCING DEVICE AND OPTICAL INFORMATION RECORDING/REPRODUCING METHOD

(71) Applicant: Hitachi-LG Data Storage, Inc., Tokyo (JP)

(72) Inventors: Takeshi OGATA, Tokyo (JP); Naohito IKEDA, Tokyo (JP)

(21) Appl. No.: 15/166,575

(22) Filed: May 27, 2016

(30) Foreign Application Priority Data
Jun. 5, 2015 (JP) 2015-114423

(51) Int. Cl. G11B 7/0065; G11B 7/125

(52) U.S. Cl. CPC G11B 7/0065; G11B 7/125

(57) ABSTRACT

An optical information recording/reproducing device that uses a signal beam and a reference beam to record digital information on an optical information storage medium by angle multiplexing using holography includes a light source unit generating a reference beam and a signal beam, and a recording angle control unit controlling an angle of the reference beam irradiated on the optical information storage medium in an angle direction in which the angle multiplexing recording is performed. The reference beam is irradiated on an unrecorded portion of the optical information storage medium when an incident angle of the reference beam is being changed by the recording angle control unit, and thereafter, the signal beam and the reference beam are irradiated on the optical information storage medium to record the digital information.

### CLAIM OF PRIORITY

The present application claims priority from Japanese patent application serial No. JP2015-114423, filed on Jun. 5, 2015, the content of which is hereby incorporated by reference into this application.

### BACKGROUND OF THE INVENTION

### (1) Field of the Invention

The present invention relates to an optical information recording/reproducing device and an optical information recording/reproducing method which record/reproduce information from a storage medium by using holography.

### (2) Description of the Related Art

At present, a consumer optical disk having a recording capacity of approximately 50 GB has been merchandised by the Blu-ray Disc™ standard using a blue-violet semiconductor laser. In the future, even the optical disc is desired to have a large recording capacity which is equal to an HDD (Hard Disk Drive) capacity, i.e., several terabytes.

However, in order to achieve a super-high-density optical disc, a high-densification technique using a new scheme which is different from that of a high-densification technique using wavelength shortening and an increase in numerical aperture of an objective lens is necessary.

In studies related a next-generation storage technique, a holographic recording technique which records digital information by using holography has attracted attentions.

In the holographic recording technique, a signal beam including information of page data two-dimensionally modulated with a spatial light modulator is superposed on a reference beam in a storage medium, and an interference pattern generated at this time causes refractive index modulation in the storage medium to record the information in the storage medium.

In reproduction of the information, when the reference beam used in the recording is irradiated on the storage medium, a hologram recorded in the storage medium acts like a diffraction grating to generate a diffracted beam. This diffracted beam involves the recording signal beam and phase information and is reproduced as a single beam.

The reproduced signal beam is two-dimensionally detected at a high speed with a photodetector such as a CMOS or a CCD. As described above, the hologram recording technique allows one hologram to record two-dimensional information in the optical storage medium at once and to reproduce the information, and to overwrite a plurality of page data at a certain position on the storage medium. Thus, a large amount of information can be recorded and reproduced at a high speed.

As the hologram recording technique, for example, Japanese Unexamined Patent Publication No. 2004-272268 (Patent Literature 1) is given. This publication discloses a “multiplexing method and device in which holograms are spatially multiplexed by partially spatial superposition between adjacent stacks of a hologram”.

In an optical information recording/reproducing device recording digital information by using holography, in addition to an optical system which generates a signal beam and a reference beam to irradiate the beams on a storage medium, an optical system which generates cure optical beams used for pre-cure and post-cure to irradiate the beams on the storage medium is independently necessary. The pre-cure is a pre-process in which a predetermined optical beam is irradiated in advance when a hologram is being recorded, and the post-cure is a post-process in which, after information is recorded at a desired position, an optical beam is irradiated to make it impossible to perform additional recording at the desired position. In the pre-cure and the post-cure, the optical beams specialized in cure are generally used. However, Japanese Unexamined Patent Publication No. 2009-076171 (Patent Literature 2) discloses an example in which a reference optical beam is used in place of a cure beam to miniaturize a device.

### Problem to be Solved by the Invention

When the reference optical beam described in Patent Literature 2 is used in place of a cure beam, an experiment by the inventor causes a new problem to be discovered. The problem will be described below. The reference optical beam is a beam having high-coherence characteristics because an interference pattern generated by interference of the reference optical beam with a signal beam is recorded as a hologram. When the reference optical beam described above was irradiated on a storage medium in a pre-cure state, a phenomenon which allows the reference optical beam to be reflected by the rear surface of the storage medium was observed. It was found that, when the phenomenon occurred, a beam being incident on the storage medium interfered with a beam reflected by the rear surface of the storage medium to generate an unnecessary hologram which should not be essentially generated. Since the unnecessary hologram generated in the pre-cure state serves as a large noise source when holograms on which information is recorded is reproduced after the cure process, the unnecessary holograms causes deterioration of reproduction quality. The patent literature does not disclose a method to solve the above-mentioned problem.

It is an object of the present invention to solve the problem occurring in application of a high-coherence beam to a cure process. A characteristic cure method according to the present invention is applied to make it possible to achieve the object.

### SUMMARY OF THE INVENTION

The problem is improved with the invention described in, for example, the scope of claims.

According to the present invention, a problem posed when a cure process is performed by using a high-coherence beam is improved to make it possible to apply the high-coherence beam as a cure beam. In this manner, miniaturization of the device and an accurate cure process can be achieved.

### BRIEF DESCRIPTION OF THE DRAWINGS

FIG. 1 is a flow chart of a pre-cure method according to a first embodiment.

FIG. 2 is a block diagram of an optical information recording/reproducing device according to the first embodiment.

FIG. 3 is a block diagram showing the optical information recording/reproducing device according to the first embodiment in an information recording state.

FIG. 4 is a block diagram showing the optical information recording/reproducing device according to the first embodiment in an information reproducing state.

FIG. 5 is a conceptual diagram obtained when a high-coherence beam is incident on an optical information storage medium.

FIG. 6A is an operational flow chart of an optical information storage medium according to the first embodiment.

FIG. 6B is an operational flow chart of the optical information storage medium according to the first embodiment.

FIG. 6C is an operational flow chart of the optical information storage medium according to the first embodiment.

FIG. 7 is a correlation diagram of irradiation energy and consumption M# of the optical information storage medium.

FIG. 8 is a correlation diagram of a reference beam Bragg angle and a reference beam pitch angle of a hologram on which only a 1-page record is recorded.

FIG. 9 is a conceptual diagram of an angle of incidence of a reference beam with respect to the optical information storage medium when a reference beam pitch angle changes.

FIG. 10 is a flow chart of a pre-cure method according to a second embodiment.

FIG. 11 is a flow chart of a pre-cure method according to the second embodiment.

FIG. 12 is a flow chart of a pre-cure method according to a third embodiment.

### DETAILED DESCRIPTION OF THE PREFERRED EMBODIMENTS

Embodiments of the present invention will be described below with reference to the accompanying drawings.

### First Embodiment

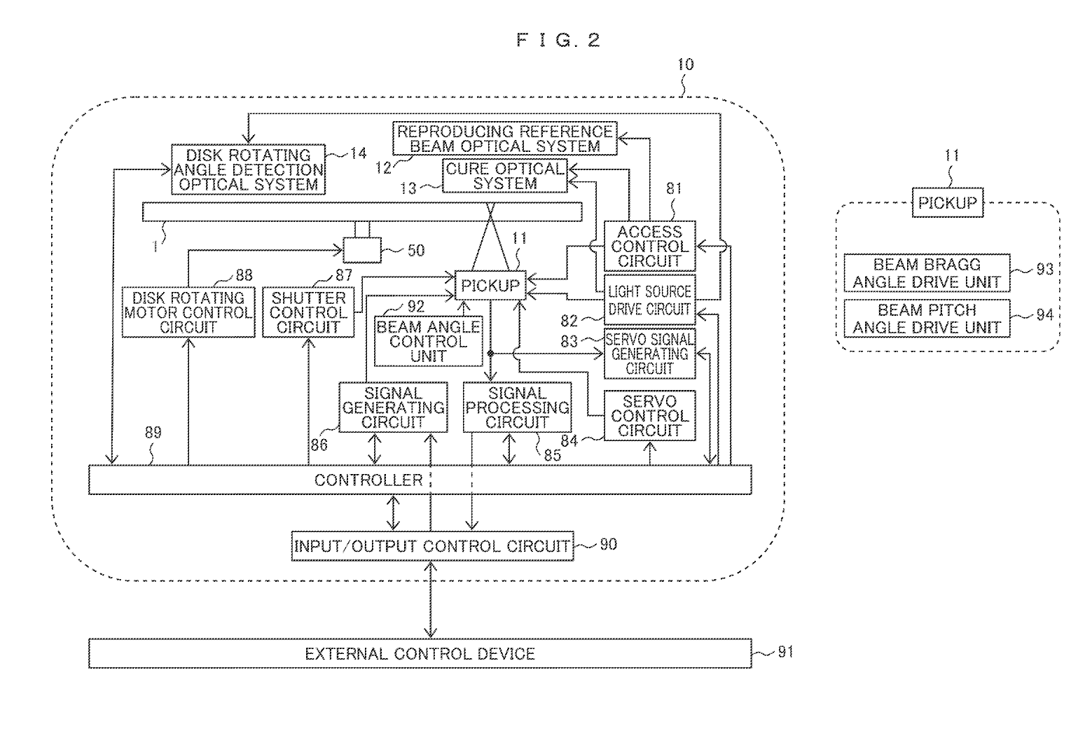

An embodiment of the present invention will be described below with reference to the accompanying drawings. FIG. 2 is a block diagram showing an optical information storage medium recording/reproducing device which records and/or reproduces digital information by using holography.

An optical information recording/reproducing device 10 is coupled to an external control device 91 through an input/output control circuit 90. In a recording state, the optical information recording/reproducing device 10 receives an information signal to be recorded from the external control device 91 through the input/output control circuit 90.

The optical recording/reproducing device 10 includes a pickup 11, a reproducing reference beam optical system 12, a cure optical system 13, a disk rotating angle detection optical system 14, and a rotating motor 50. The optical information storage medium 1 is configured to be able to be rotated with the rotating motor 50.

The pickup 11 fulfills a role that irradiates a reference beam and a signal beam on the optical information storage medium 1 to record digital information in a storage medium by using holography. At this time, a controller 89 sends the information signal to be recorded to a spatial light modulator in the pickup 11 through a signal generating circuit 86 to cause the spatial light modulator to modulate a signal beam. The pickup 11 causes a beam angle control unit 92 for controlling an angle of irradiation of a reference beam to arbitrarily control an angle of irradiation to the optical information storage medium 1. The pickup 11 includes a beam Bragg angle drive unit 93 driving a reference optical beam in a direction in which angle multiplexing recording is performed and a beam pitch angle drive unit 94 driving a reference beam angle in an angle direction perpendicular to the beam Bragg angle drive unit 93.

When information recorded in the optical information storage medium 1 is to be reproduced, the reproducing reference beam optical system 12 generates a light wave which allows a reference beam emitted from the pickup 11 to be incident on the optical information storage medium in a direction opposing a direction in the recording state. A reproduced beam reproduced by a reproducing reference beam is detected with a photodetector (will be described later) in the pickup 11 to reproduce a signal with a signal processing circuit 85.

Exposure times of the reference beam and the signal beam irradiated on the optical information storage medium 1 can be adjusted such that the controller 89 controls an opening/closing time of a shutter in the pickup 11 through a shutter control circuit 87.

The disk rotating angle detection optical system 14 is used to detect a rotating angle of the optical information storage medium 1. When the optical information storage medium 1 is adjusted to a predetermined rotating angle, the disk rotating angle detection optical system 14 detects a signal generated depending on the rotating angle, and the controller 89 can control the rotating angle of the optical information storage medium 1 by using the detected signal through a disk rotating motor control circuit 88.

A predetermined light source drive current is supplied from a light source drive circuit 82 to light sources in the pickup 11, the cure optical system 13, and the disk rotating angle detection optical system 14 to make it possible to cause the light sources to emit optical beams at predetermined amounts of light.

The pickup 11 and the disk cure optical system 13 include mechanisms which can slide their positions in a radial direction of the optical information storage medium 1 to perform position control through an access control circuit 81.

A recording technique using angle multiplexing of holography tends to have an extremely small allowable error with respect to a shift of a reference beam angle.

Thus, a mechanism detecting a shift amount of the reference beam angle is disposed in the pickup 11, a servo signal generating circuit 83 generates a servo control signal, and a servo mechanism to correct the shift amount through a servo control circuit 84 must be included in the optical information recording/reproducing device 10.

The pickup 11, the cure optical system 13, and the disk rotating angle detection optical system 14 may be simplified such that some optical system configurations or all the optical system configurations may be collected up.

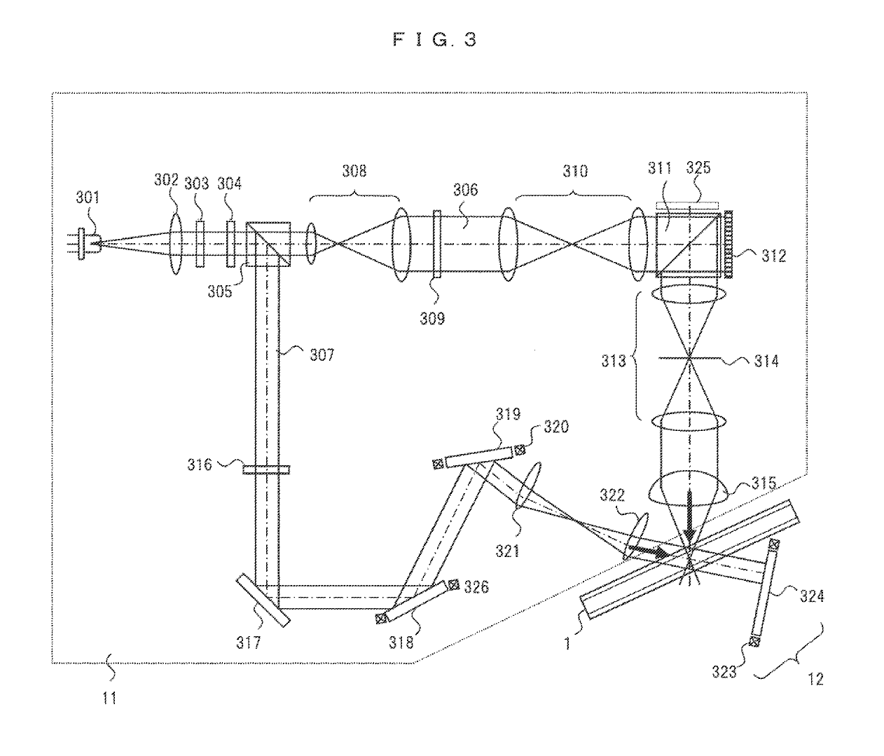

FIG. 3 shows a recording principle in an example of a basic optical system configuration of the pickup 11 in the optical information recording/reproducing device 10. An optical beam emitted from a light source 301 passes through a collimate lens 302 and then is incident on a shutter 303. When the shutter 303 opens, after the optical beam passes through the shutter 303, the polarizing direction of the optical beam is controlled such that a light amount ratio of p polarization and s polarization is made into a desired ratio with an optical element 304 constituted by, for example, a ½-wavelength plate. Thereafter, the optical beam is incident on a PBS (Polarization Beam Splitter) prism 305.

The optical beam passing through the PBS prism 305 works as a signal beam 306, is expanded in optical beam diameter with a beam expander 308, passes through a phase mask 309, a relay lens 310, and a PBS prism 311, and then is incident on a spatial light modulator 312.

The signal beam to which information is added by the spatial light modulator 312 is reflected by the PBS prism 311 and propagated through the relay lens 313 and a spatial filter 314. Thereafter, an objective lens 315 converges the signal beam on the optical information storage medium 1.

On the other hand, the optical beam reflected by the PBS prism 305 works as a reference beam 307, is set with a polarizing direction conversion element 316 to have a predetermined polarizing direction depending on a recording state or a reproducing state, and then is incident on a galvanometer mirror 318 and a galvanometer mirror 319 through a mirror 317. Since the angles of the galvanometer mirror 318 and galvanometer mirror 319 can be adjusted by an actuator 326 and an actuator 320, respectively, an angle of incidence of the reference beam being incident on the optical information storage medium 1 after the reference beam passes through a lens 321 and a lens 322 can be set to a desired angle. In order to set the angle of incidence of the reference beam, in place of galvanometer mirror, an element converting a wavefront of the reference beam may be used.

In this manner, the signal beam and the reference beam are incident on the optical information storage medium 1 while being superposed on each other to form an interference pattern in the storage medium, and the pattern is written in the storage medium to record the information. Since the galvanometer mirror 319 can change an angle of incidence of the reference beam being incident on the optical information storage medium 1, recording by angle multiplexing can be achieved.

In the following description, of holograms recorded at variable reference beam angles in the same region, holograms respectively corresponding to reference beam angles are called pages, and a set of pages angle-multiplexed in the same region is called a block.

A direction of an angle of incidence of a reference beam which performs angle multiplexing recording is called a Bragg angle, and a direction of an angle perpendicular to the Bragg angle is called a pitch angle.

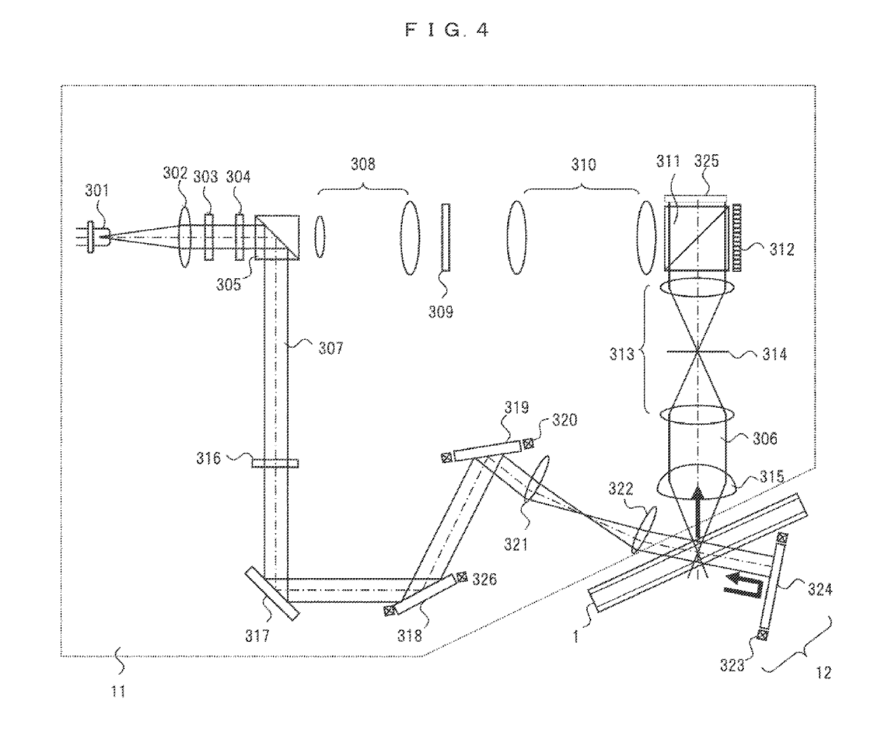

FIG. 4 is a reproducing principle in an example of a basic optical system configuration of the pickup 11 in the optical information recording/reproducing device 10. When recorded information is to be reproduced, as described above, a reference beam is incident on the optical information storage medium 1, and the optical beam passing through the optical information storage medium 1 is reflected with a galvanometric mirror 324 the angle of which can be adjusted with an actuator 323 to generate a reproducing reference beam of the optical beam.

When a reproduced beam reproduced with the reproducing reference beam propagates through the objective lens 315, the relay lens 313, and the spatial filter 314. Thereafter, the reproduced beam passes through the PBS prism 311 and is incident on a photodetector 325 to make it possible to reproduce the recorded signal. Although an image pickup element such as a CMOS image sensor or a CCD image sensor can be used as the photodetector 325, any element which can reproduce page data may be used.

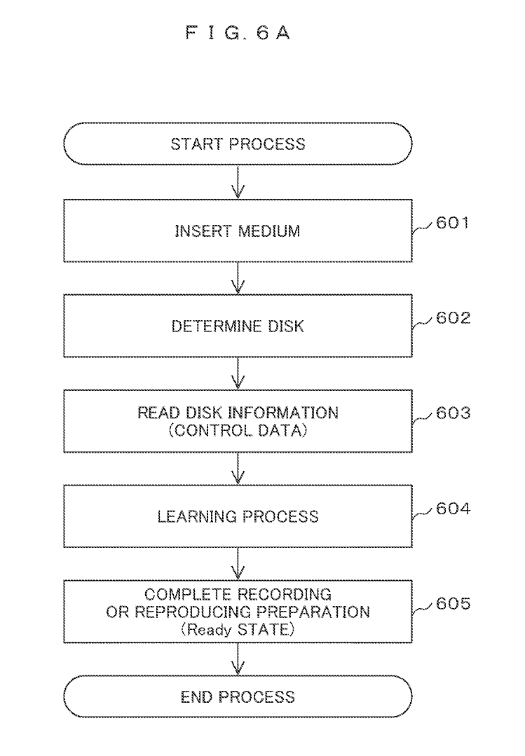

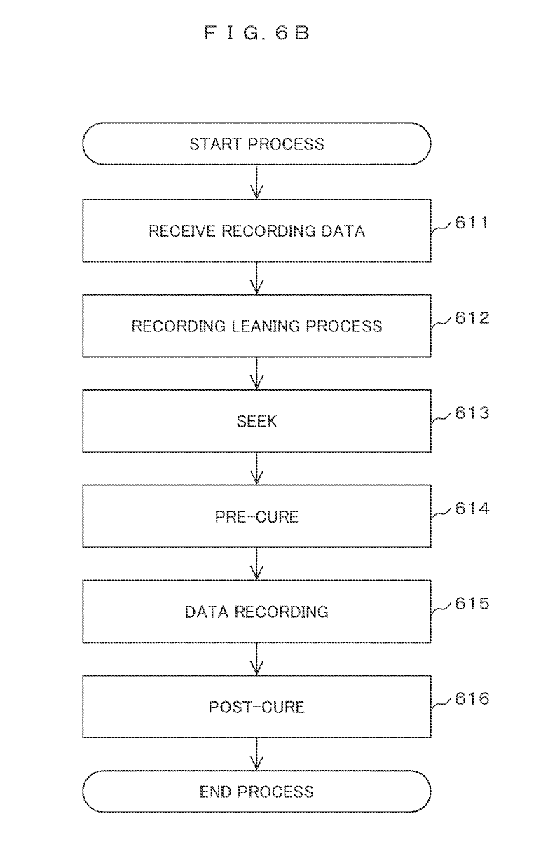

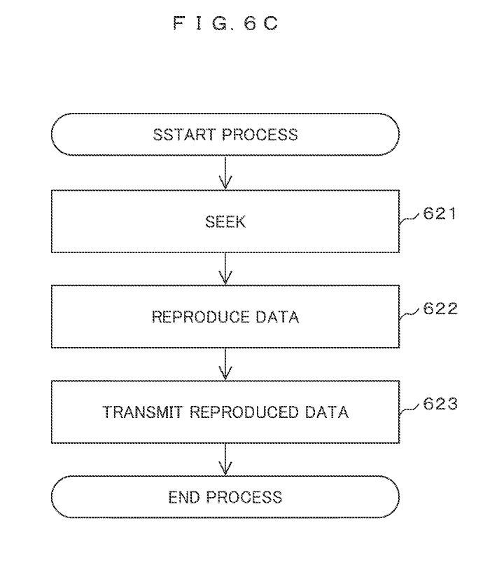

FIGS. 6A to 6C show operational flows of recording/reproducing in the optical information recording/reproducing device 10. A flow related to recording/reproducing using holography will be especially described here.

FIG. 6A shows an operational flow of an operation performed until preparation for recording or reproducing is completed after the optical information storage medium 1 is inserted into the optical information recording/reproducing device 10, FIG. 6B shows an operation performed until information is recorded in the optical information storage medium 1 in a preparation completion state, and FIG. 6C shows an operational flow of an operation performed until the information recorded in the optical information storage medium 1 is reproduced in the preparation completion state.

When the medium is inserted (601) as shown in FIG. 6A, the optical information recording/reproducing device 10 makes a disk determination to check whether, for example, the inserted medium is a medium in which digital information is recorded or reproduced by using holography (602).

As a result of the disk determination, when it is determined that the medium is an optical information storage medium in which digital information is recorded or reproduced by using holography, the optical information recording/reproducing device 10 reads control data stored in the optical information storage medium (603) to acquire, for example, information related to the optical information storage medium or, for example, information related to various setting conditions in a recording or reproducing state.

After the control data is read, various adjustments depending on the control data and a learning process related to the pickup 11 (604), and the optical information recording/reproducing device 10 completes preparation for recording or reproducing (605).

In the operational flow of the operation performed until the information is recorded in the preparation completion state, as shown in FIG. 6B, data to be recorded is received first (611), and information depending on the data is sent to the spatial light modulator in the pickup 11.

Thereafter, in order to make it possible to record high-quality information in the optical information storage medium, as needed, for example, various recording learning processes such as power optimization of the light source 301 and optimization of a time of exposure performed with the shutter 303 are performed in advance (612).

Thereafter, in a seek operation (613), the access control circuit 81 is controlled to assign the positions of the pickup 11 and the cure optical system 13 to predetermined positions on the optical information storage medium. When the optical information storage medium 1 has address information, the address information is reproduced, it is checked whether the positions are assigned to target positions, respectively. When the positions are not assigned to the target positions, respectively, shift amounts between the positions and the predetermined positions are calculated, and the positioning operation is repeated again.

Thereafter, pre-cure is performed to a predetermined region by using an optical beam emitted from the cure optical system 13 (614), and data is recorded by using a reference beam and a signal beam emitted from the pickup 11 (615).

After the data is recorded, post-cure is performed by using an optical beam emitted from the cure optical system 13 (616). The data may be verified as needed.

In an operational flow performed until the recorded information is reproduced in the preparation completion state, as shown in FIG. 6C, the access control circuit 81 is controlled in the seek operation (621) to assign the positions of the pickup 11 and the reproducing reference beam optical system 12 to predetermined positions on the optical information storage medium. When the optical information storage medium 1 has address information, the address information is reproduced, and it is checked whether the positions are assigned to the target positions, respectively. When the positions are not assigned to the target positions, respectively, shift amounts between the positions and the predetermined positions are calculated, and the positioning operation will be repeated again.

Thereafter, a reference beam is emitted from the pickup 11 to read information recorded on the optical information storage medium (622), and the reproduced data is transmitted (623).

A method of preventing reproduction quality of data from being deteriorated even when a pre-cure process is executed by using a high-coherence beam examined by the inventor will be described in detail.

A supplementary explanation for the pre-cure process will be made. As described above, the pre-cure is a pre-process in which a predetermined optical beam is irradiated in advance before a reference beam and a signal beam are irradiated on a predetermined position when information is recorded at a desired position in the optical information storage medium.

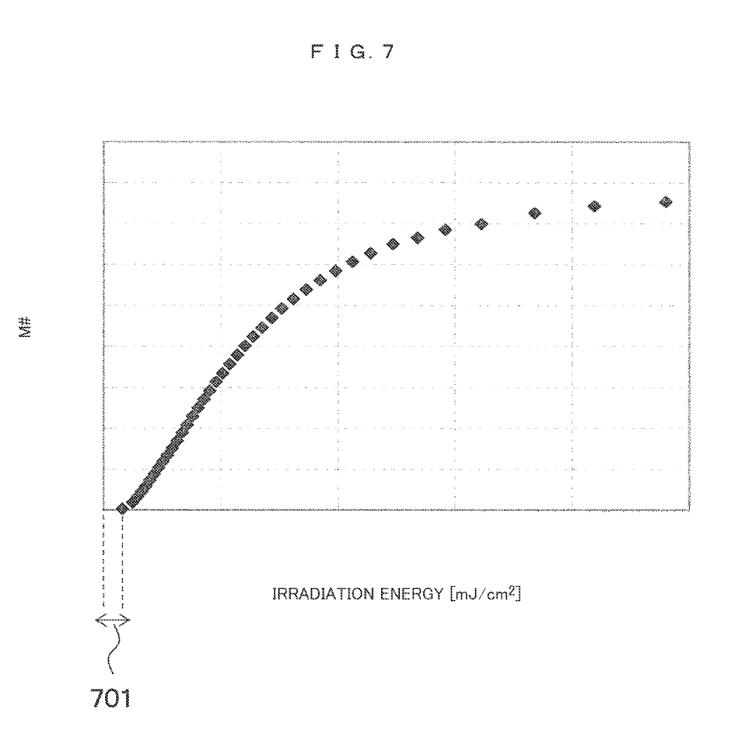

FIG. 7 shows an example of the characteristics of an optical information storage medium made of a photopolymer material and serving as an example of an optical information storage medium to record information by using the principle of photography. An abscissa shows energy exposed to the optical information storage medium, and an ordinate shows indexes representing medium characteristics called M/# (M number). The M/# is an index required to generate a hologram on the optical information storage medium. When the M/# increases, the number or the density of holograms which can be recorded on the optical information storage medium can be increased. When energy having a desired wavelength is exposed to the optical information storage medium, the reference beam and the signal beam are superposed on each other to generate an interference pattern, and the interference pattern is recorded on the optical information storage medium as a hologram by consumption of the M/# of the optical information storage medium. However, in order to obtain a state in which the optical information storage medium consumes the M/# to make it possible to record a hologram, energy in a reaction activation state must be exposed to the optical information storage medium in advance.

Energy 701 in FIG. 7 becomes the energy in the reaction activation state. For this reason, before information is recorded on the optical information storage medium, before the reference beam and the signal beams for information recording are irradiated, a predetermined optical beam is irradiated to inject energy into the optical information storage medium in advance, and a desired region must be set in the reaction activation state. This recording pre-process is called pre-cure. As energy for the pre-cure, only the energy indicated by 701 is ideally accurately injected. However, various events such as uneven irradiation energy caused by an optical system of a device and an increase/decrease in energy 701 by temperature dependency or the like of medium sensitivity are involved in the energy for pre-cure. For this reason, irradiation energy is difficult to be strictly adjusted. However, in order to reliably record information after the pre-cure, energy equal to or larger than the energy 701 need only be irradiated in a pre-cure state.

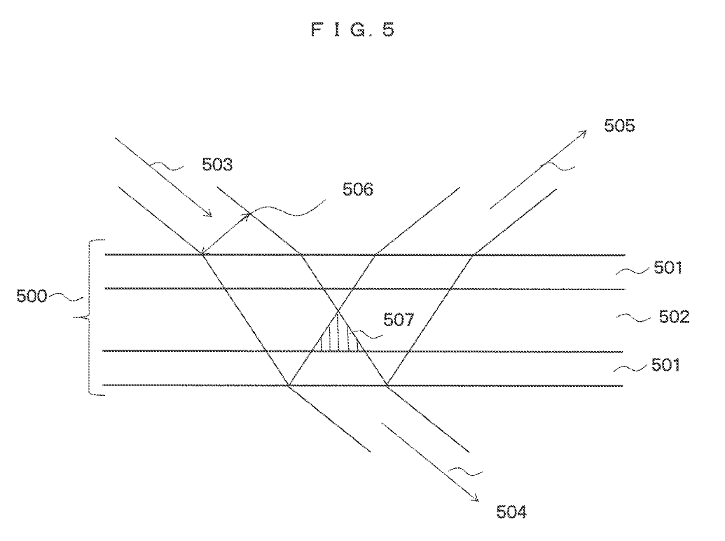

A phenomenon occurring when a pre-cure process is executed by using a high-coherence beam will be described below with reference to FIG. 5. FIG. 5 shows a manner obtained when a high-coherence beam is irradiated on an optical information storage medium in which data is recorded by the principle of holography. Reference numerals 501 and 502 denote elements constituting an optical information storage medium 500, reference numeral 502 denotes a layer into a recording material is injected, and reference symbol 501 denotes cover layers sandwiching a recording material 502 therebetween and shows a diagram when viewed from a section of the optical information storage medium. Reference numeral 503 denotes a high-coherence beam irradiated on the optical information storage medium. As an example, the refractive indexes of the elements 501 and 502 are set to the same refractive index, and the refractive indexes of the elements 501 and 502 are set to a refractive index different from a refractive index in the air.

When a high-coherent beam 503 is incident on the optical information storage medium 500, the difference between the refractive index of the incident beam in the air and the refractive index of the optical information storage medium 500 causes refraction of the beam in an incident state to linearly propagate the beam through the optical information storage medium 500 at different angles. Thereafter, the beam 503 splits into a beam 504 passing through the optical information storage medium 500 and a beam 505 reflected by the rear surface of the cover layer 501. In this case, since the beam 503 has a beam width 506, the beam reflected by the rear surface of the cover layer 501 partially overlaps a part of the incident beam. In this case, since the incident beam 503 is a high-coherence beam, the beams interfere with each other in a region in which the incident beam and the reflected beam overlap to generate an interference pattern. When the irradiated energy exceeds the energy 701 in FIG. 7, the interference pattern is recorded in a layer 502 into which a recording material is injected as a hologram 507.

As described above, when, for pre-cure, a reference beam serving as a high-coherence beam is irradiated on the optical information storage medium 500, independently of a pre-cure effect achieved by energy injection, the incident reference beam and the reference beam reflected by the rear surface of the optical information storage medium 500 interfere with each other to generate an unnecessary hologram. This region is a region used to record information to be recorded as a hologram after a pre-cure process. In data recording, the reference beam and the signal beam are irradiated on the region to be interfered with each other, thereby generating a hologram.

At this time, when a reference beam irradiation angle in a pre-cure state is equal to a reference beam irradiation angle in information recording, when, in order to reproduce a hologram in which information is recorded, a reference beam angle in reproducing is adjusted to an angle suitable for the recorded hologram, the reference beam angle becomes an angle suitable for reproduction of an unnecessary hologram. As a result, the hologram on which the information is recorded is reproduced, and the unnecessary hologram generated in the pre-cure state is reproduced at the same time. In this case, a reproduction image received by a sensor such as a camera is an image obtained by overlapping the component of a reproduction image of the hologram on which the information is recorded and the component of a reproduction image of the unnecessary hologram generated in the pre-cure state, the reproduction image of the information to be essentially acquired includes a noise component to deteriorate the reproduction quality. More specifically, an error rate of the reproduction image increases to make it difficult to recover the recorded information. For this reason, in order to use a high-coherent beam as a beam in a pre-cure state, the problem described above must be solved.

A method of avoiding or reducing an influence of an unnecessary hologram generated with an incident beam and a reflected beam which are high-coherence beams will be described below. As described above, an unnecessary hologram generated with a high-coherence incident beam and an in-medium reflected beam also exhibits a change in diffracted beam intensity depending on an angle of a reference beam like a hologram normally recorded.

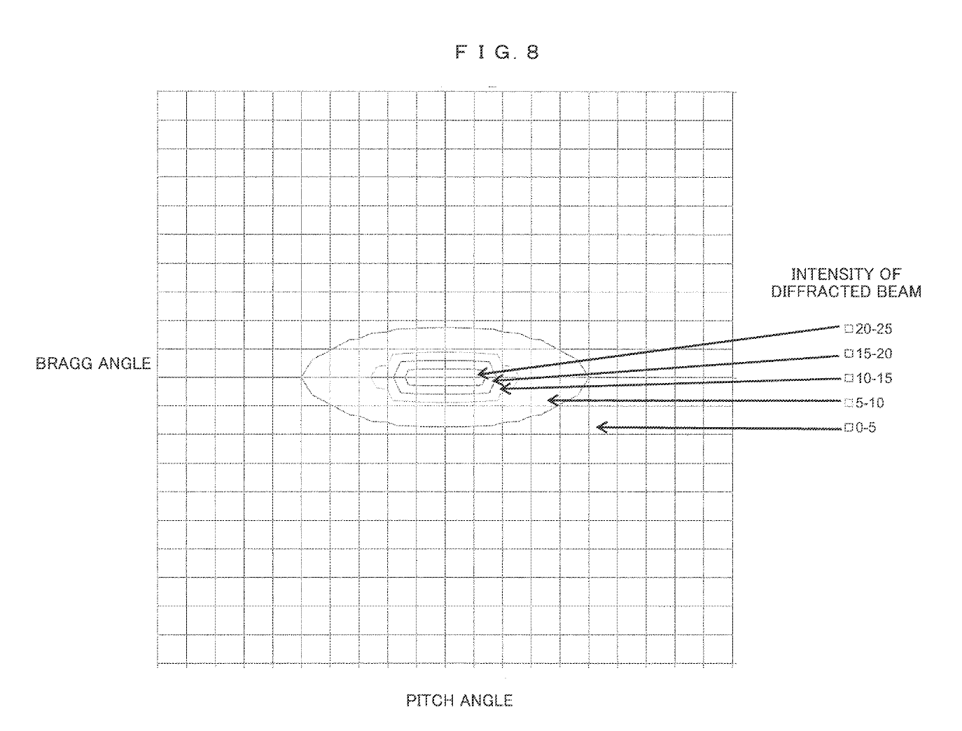

FIG. 8 shows intensity distributions of hologram diffracted beams at a Bragg angle and a pitch angle. It is confirmed that the hologram diffracted beam has angular selectivities with respect to the Bragg angle and the pitch angle. The angular selectivity is a characteristic in which a generated hologram can be reproduced within only a certain angle range in reproduction of the hologram, and the angle multiplexing recording described above is achieved by using the characteristic. According to the characteristic, when a reference beam is irradiated at an angle shifted from the angle of a reference beam with which a hologram is recorded by a predetermined angle, the desired hologram cannot be reproduced. In contrast to this, even in the same region, when a hologram is recorded at an irradiation angle shifted from a reference beam irradiation angle at which the hologram is recorded at the beginning by a predetermined angle, a new hologram can be recorded at an angle different from the angle of the hologram recorded at the beginning. In reproduction of the hologram recorded at the beginning and a hologram recorded thereafter, the angles of reference beams are adjusted to angles set when the holograms are recorded to make it possible to independently reproduce desired data.

In the angle multiplexing recording, angle multiplexing recording is performed in a Bragg angle direction having a low angle selectivity to reduce an influence of an adjacent page, interference between pages when holograms are recorded at equal angular intervals can be reduced. Thus, in the angle multiplexing recording, multiplexing recording is advantageously performed in a Bragg angle direction.

Even in a hologram generated with pre-cure performed by a reference beam, the same angle selectivity described above occurs. When pre-cure is performed at an angle changed into an angle of a Bragg angle direction as in a page in which information is recorded, it is disadvantageously impossible to record information in a Bragg angle range in which the influence of a hologram generated by pre-cure remains. This problem can be solved such that the angle of the reference beam is changed in a pitch direction. Since a pitch angle has an angle selectivity, which is moderate, an interval between a pitch angle at which information is recorded and a pitch angle at which pre-cure is performed is changed within a range in which an influence of a diffracted beam of a hologram is eliminated to make it possible to prevent a page on which information is recorded from being influenced by a hologram generated by the pre-cure. The pre-cure is performed at a pitch angle different from a pitch angle at which multiplexing recording of information is performed to make it possible to use all Bragg angles which can be controlled by the galvanometer mirror 319 in recording of information. For example, the number of pages on which information can be recorded can be increased when an amount of inter-page interference is not change, and a Bragg angle interval between pages can be increased to further reduce the inter-page interference when the number of pages in a book is not changed.

A method of recording/reproducing information such that pre-cure is executed with a high-interference beam by using the characteristic will be described below.

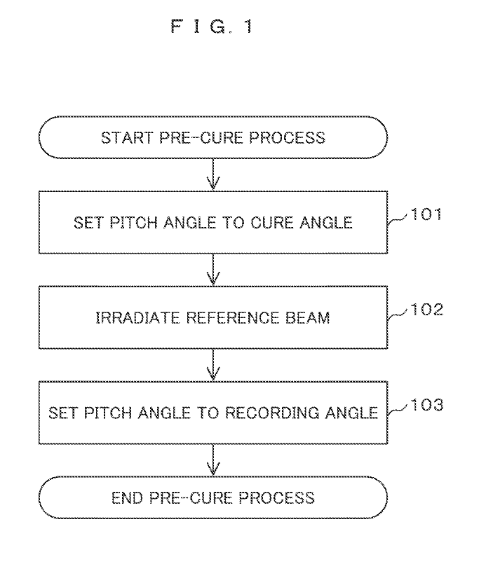

An example of a detailed sequence of the pre-cure is shown as a flow chart in FIG. 1. The flow chart in FIG. 1 is a detailed sequence of pre-cure (614) in FIG. 6B. In the pre-cure, the galvanometric mirror 318 is operated to change a pitch angle of a reference beam being incident on the optical information storage medium 1 into an angle for cure (101). Thereafter, the reference beam is irradiated on the optical information storage medium 1 (102). Thereafter, the pitch angle of the reference beam is changed into an angle for recording (103). With the processes performed up to now, the pre-cure operation is completed. Thereafter, angle multiplexing recording of data is performed to the optical information storage medium 1 while the reference beam Bragg angle is changed in data recording (615). At this time, even though an unnecessary hologram is generated in a pre-cure state, reproducing quality of a hologram in which information is recorded is not influenced in terms of the angle selectivities.

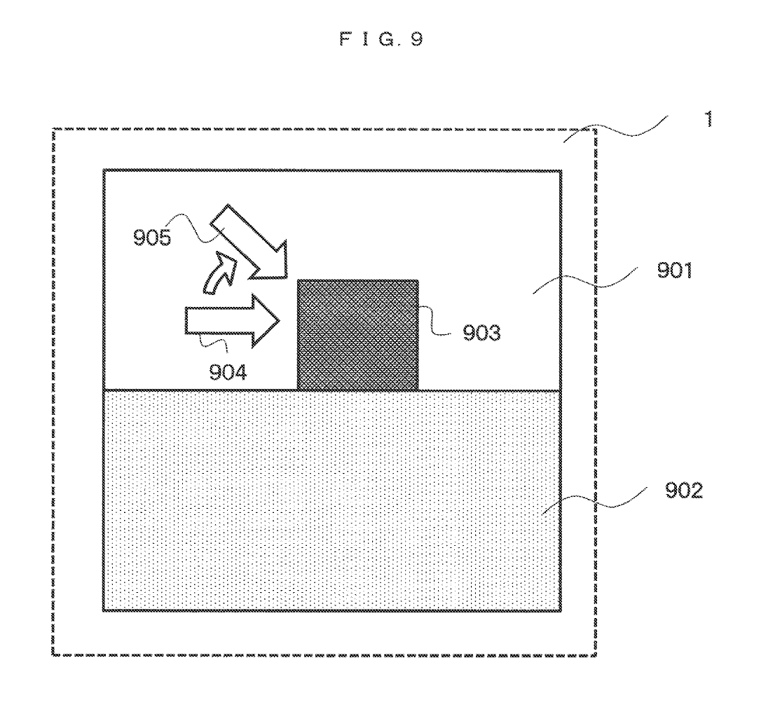

An effect of a change in direction of a pitch angle at which pre-cure is performed is shown in FIG. 9. The optical information storage medium 1 which is being recorded includes a recorded region 902 in which recording has been completed, an unrecorded region 901, and a region 903 in which recording will be performed. When the pitch angle is changed, for example, the incident angle of the reference beam changes to rotate around the region 903 in which recording is performed like a change from a direction indicated by a reference beam incident angle 904 to a direction indicated by a reference beam incident angle 905.

In pre-cure performed by a reference beam, in order to cause an internal reflected beam in the optical information storage medium 1 to being incident in a direction in the recorded region 902, a region through which the internal reflected beam of the reference beam being incident on the optical information storage medium 1 passes like the reference beam incident angle 905 is preferably changed into the recorded region 902 in which the M# is consumed. When the reference beam pitch angle is changed as described above, the consumption of the M# by unnecessary exposure to the other unrecorded region 901 in which pre-cure is being performed can be reduced.

When the pre-cure process and the recording process are executed by the above procedures, generated holograms are recorded at angles at which reproducing qualities of the holograms are not influenced on each other. For this reason, a hologram on which information is recorded is not influenced by an unnecessary hologram generated in a pre-cure state, and the hologram can be reproduced with good quality in a reproducing state. Although the execution to the pre-cure is described in the embodiment, this method can also be executed to post-cure.

### Second Embodiment

A method of irradiating a beam on the optical information storage medium 1 to perform pre-cure while a reference beam angle is changed by using the optical information recording/reproducing device 10 described in the first embodiment will be described in the second embodiment.

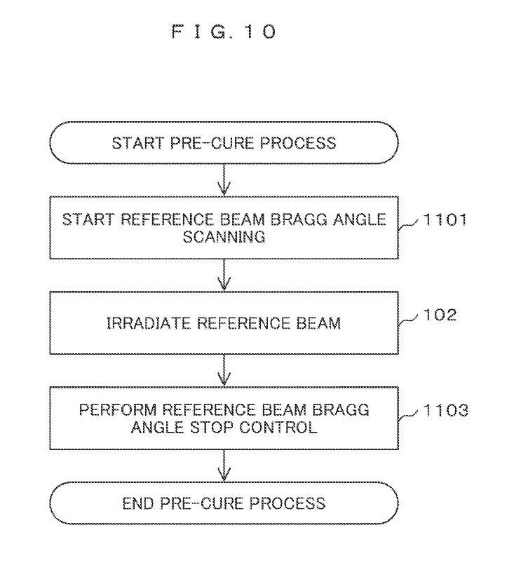

FIG. 10 shows a flow chart of a pre-cure method in the second embodiment. The flow chart in FIG. 10 is a detailed sequence of the pre-cure (614) in FIG. 6B. In the pre-cure, the galvanometric mirror 319 is operated to change a Bragg angle of a reference beam being incident on the optical information storage medium 1 (1101). The reference beam is irradiated on the optical information storage medium 1 during a change in reference beam angle (102). Thereafter, the operation of the reference beam Bragg angle is stopped (1103). With the above processes, the operation of pre-cure is completed. Thereafter, angle multiplexing recording of data is performed to the optical information storage medium 1 while the reference beam Bragg angle is changed in data recording (615).

In this manner, when the reference beam is irradiated on the optical information storage medium 1 while the reference beam Bragg angle is changed, the diffracted beam intensity of a hologram to be generated is in proportion to the M# consumed at angles of reference beams which are being irradiated. Since amounts of hologram diffracted beam generated by pre-cure decrease at the reference beam angles, respectively, an influence on reproducing quality can be considerably reduced, and preferable reproducing quality can be obtained.

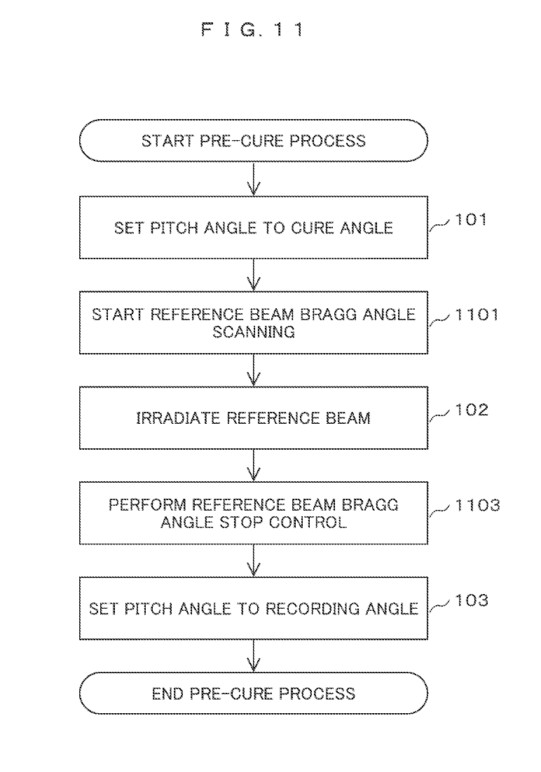

As in the flow chart shown in FIG. 11, when a process of changing the pitch angles shown in the first embodiment is added before the reference Bragg angle is scanned, an influence on a hologram on which information is recorded can be reduced.

When an angular speed is made constant in a process (1101) of changing a Bragg angle of a reference beam being incident on the optical information storage medium 1, influences of holograms generated by pre-cure at the angles can be made equal to each other. When an angle range of the Bragg angle in the process (1101) of changing the Bragg angle of a reference beam being incident on the optical information storage medium 1 is set to an angle range in which an influence of noise is small, a reproduction error caused by an increase in noise by pre-cure can be reduced.

Although the execution to the pre-cure is described in the embodiment, this method can also be executed to post-cure.

### Third Embodiment

When a reference radius is reduced to suppress the influence of a reference beam on an adjacent book, pre-cure must be performed to each recording book when pre-cure is performed by using the reference beam. In the third embodiment, the pre-cure operation and a data recording operation are performed such that the operation efficiency of the galvanometric mirror 319 is preferable. A method of irradiating a reference beam on the optical information storage medium 1 to continuously perform the pre-cure operation and the recording operation while the reference beam angle is changed by using the optical information recording/reproducing device 10 described in the first embodiment will be described below.

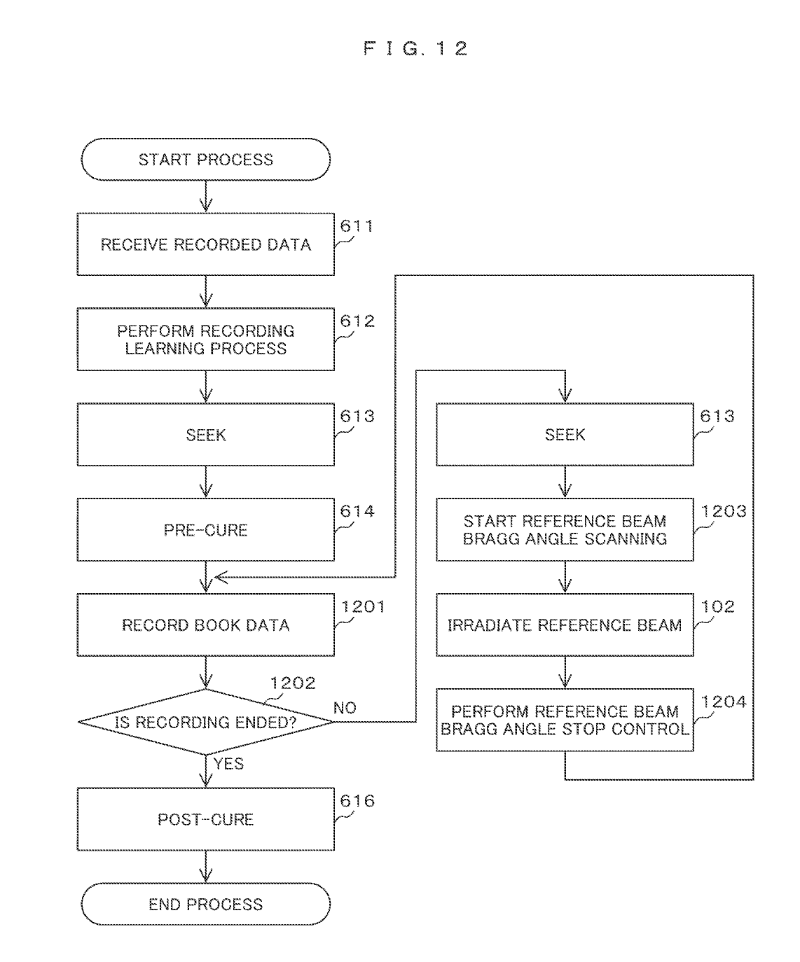

FIG. 12 shows a flow chart of recording in the third embodiment. Data to be recorded is received first (611), and information depending on the data is sent to a spatial light modulator in the pickup 11.

Thereafter, in order to record high-quality information in the optical information storage medium, various recording learning processes such as power optimization of the light source 301 and optimization of an exposure time by the shutter 303 are performed in advance (612).

Thereafter, the access control circuit 81 is controlled in the seek operation (613) to assign the positions of the pickup 11 and the cure optical system 13 to predetermined positions on the optical information storage medium, respectively. When the optical information storage medium 1 has address information, the address information is reproduced, and it is checked whether the positions are assigned to target positions, respectively. When the positions are not assigned to the target positions, respectively, shift amounts between the positions and the predetermined positions are calculated, and the positioning operation is repeated again.

Thereafter, pre-cure is performed to a predetermined region by using a reference beam emitted from the pickup 11 (614), and, while reference beam Bragg angle is positioned to a plurality of angles in the same angle direction, data of one book are recorded by using a reference beam and a signal beam emitted from the pickup 11 (1201). After the data of one book are recorded, it is determined based on the received data whether the recording is ended (1202). When the recording will be ended, post-cure is performed by using an optical beam emitted from the cure optical system 13 (616). The data may be verified as needed. When it is determined in the recording end determination (1202) that the recording is continued, a seek operation is performed to a region in which recording will be performed next (613). Thereafter, the Bragg angle of the reference beam is set to an angle of a page on which information is recorded at the beginning in the book to start scanning (1203). The reference beam is irradiated on the optical information storage medium 1 during a change in reference beam angle (102). After the reference beam is irradiated, the Bragg angle of the reference beam is stopped at the angle of a page on which information is recorded at the beginning in the book (1204).

Thereafter, the data of one book are recorded by using the reference beam and the signal beam emitted from the pickup 11 while the Bragg angle of the reference beam is assigned to a plurality of angles in the same angle direction (1201).

When the recording is performed as described above, the operation of the Bragg angle of the reference beam performed by pre-cure and the positioning process of the reference beam Bragg angle for the first page to record information can be simultaneously performed. Thus, in comparison with a case in which the pre-cure operation and the positioning operation for the first page are independently performed, an information recording rate can be increased.

Since a consumption of time to perform pre-cure can be reduced by applying the embodiment, a reference beam diameter on the optical information storage medium can be reduced, and the number of noise holograms formed in an adjacent recording region can be reduced.

When all directions in which pieces of information are recorded are made equal to each other in information recording, recording qualities in the M# used to record the same pages of books can be easily made equal to each other.

When an angular speed of the process (1203) of changing a Bragg angle of a reference beam being incident on the optical information storage medium 1 is made constant, influences of holograms generated by pre-cure at the angles can be made uniform.

When a Bragg angle in the process (102) of irradiating a reference beam is set within an angle range in which an influence of noise is small, the number of reproducing errors caused by an increase in noise by pre-cure can be reduced.

When the embodiment is applied, an increase in transfer rate of the optical information recording device 10 and equalization of qualities of recorded holograms can be achieved.

The present invention is not limited to the embodiments described above, and includes various modifications. For example, the embodiments described above have been described in detail to understandably explain the present invention, and are not always limited to an embodiment including all the configurations described above. Some of the configurations of a certain embodiment can be replaced with corresponding configurations of anther embodiment, and to configurations of a certain embodiment, a configuration of another embodiment can also be added.

What is claimed is:

1. An optical information recording/reproducing device that uses a signal beam and a reference beam to record digital information on an optical information storage medium by angle multiplexing using holography, comprising:
a light source unit generating a reference beam and a signal beam; and
a recording angle control unit controlling an angle of the reference beam irradiated on the optical information storage medium in an angle direction in which the angle multiplexing recording is performed, wherein
the reference beam is irradiated on an unrecorded portion of the optical information storage medium when an incident angle of the reference beam is being changed by the recording angle control unit, and
thereafter, the signal beam and the reference beam are irradiated on the optical information storage medium to record the digital information.

2. The optical information recording/reproducing device according to claim 1, comprising
a cure process angle control unit controlling an angle of the reference beam being irradiated on the optical information storage medium in a direction different from the direction of the recording angle control unit, wherein
the angle of the reference beam is set to a first angle by using the cure process angle control unit, the reference beam is irradiated on an unrecorded portion of the optical information storage medium when the incident angle of the reference beam is being changed by the recording angle control unit,
the angle of the reference beam is set to a second angle by using the cure process angle control unit, and the signal beam and the reference beam are irradiated on the optical information storage medium to record the digital information.

3. The optical information recording/reproducing device according to claim 2, wherein
the first angle changed by using the cure process angle control unit is a direction in which, in comparison with the second angle, an internal reflected beam which is incident on the optical information storage medium is in a recorded region.

4. The optical information recording/reproducing device according to claim 1, wherein
a change angle speed of an incident angle of the reference beam by the recording angle control unit when the reference beam is being irradiated on an unrecorded portion of the optical information storage medium is made approximately constant.

5. The optical information recording/reproducing device according to claim 1, wherein
a change of the reference beam angle in a state in which the reference beam is irradiated on the unrecorded portion of the optical information storage medium when the incident angle of the reference beam is being changed by the recording angle control unit corresponds to a angle change from the reference beam angle obtained when previous recording ends to the reference beam angle obtained at the beginning in next recording.

6. An optical information recording/reproducing method that uses a signal beam and a reference beam to record digital information on an optical information storage medium by angle multiplexing using holography, wherein
the reference beam is irradiated on an unrecorded portion of the optical information storage medium in a state in which an angle of the reference beam is set to a first angle, and
after the reference beam is irradiated on the unrecorded portion, the signal beam and the reference beam are irradiated on the optical information storage medium in a state in which the angle of the reference beam is set to a second angle to record the digital information.

7. The optical information recording/reproducing method according to claim 6, wherein
the reference beam is irradiated on an unrecorded portion of the optical information storage medium when an incident angle of the reference beam is being changed in a state in which the angle of the reference beam is set to the first angle.

8. The optical information recording/reproducing method according to claim 6, wherein
the first angle is a direction in which, in comparison with the second angle, an internal reflected beam which is incident on the optical information storage medium is in a recorded region.

9. The optical information recording/reproducing method according to claim 7, wherein
a change angle speed of an incident angle of the reference beam when the reference beam is being irradiated on an unrecorded portion of the optical information storage medium is made approximately constant.

10. The optical information recording/reproducing method according to claim 6, wherein
a change of the reference beam angle in a state in which the reference beam is irradiated on the unrecorded portion of the optical information storage medium when the incident angle of the reference beam is being changed corresponds to a angle change from the reference beam angle obtained when previous recording ends to the reference beam angle obtained at the beginning in next recording.

11. An optical information recording/reproducing device that uses a signal beam and a reference beam to record digital information on an optical information storage medium by angle multiplexing using holography, comprising:
a light source unit generating a reference beam and a signal beam;
a recording angle control unit controlling an angle of the reference beam irradiated on the optical information storage medium in a direction in which the angle multiplexing recording is performed; and
a cure process angle control unit controlling an angle at which the reference beam is irradiated on the optical information storage medium to a direction different from that of the recording angle control unit, wherein
the angle of the reference beam is set to a first angle by using the cure process angle control unit, the reference beam is irradiated on an unrecorded portion of the optical information storage medium,
the angle of the reference beam is set to a second angle by using the cure process angle control unit, and the signal beam and the reference beam are irradiated on the optical information storage medium to record the digital information.
